(19) United States
(12) Patent Application Publication
(10) Pub. No.: US 2024/0384442 A1
(43) Pub. Date: Nov. 21, 2024

(54) METHOD FOR MANUFACTURING COFFEE ACTIVATED CARBON USING COFFEE WASTE, COFFEE ACTIVATED CARBON MANUFACTURED BY THE SAME, AND DOPE-DYED YARN INCLUDING COFFEE ACTIVATED CARBON

(71) Applicants: HYUNDAI MOTOR COMPANY, Seoul (KR); KIA CORPORATION, Seoul (KR)

(72) Inventor: Kwang Mo Seong, Bucheon-si (KR)

(21) Appl. No.: 18/236,813

(22) Filed: Aug. 22, 2023

(30) Foreign Application Priority Data
May 18, 2023 (KR) 10-2023-0064257

(51) Int. Cl. D01F 1/06; B01J 20/20; B01J 20/26; B01J 20/28; B01J 20/30; C01B 32/318; C01B 32/336; C01B 32/354; D01F 6/06; B01D 53/02

(52) U.S. Cl. CPC D01F 1/06; B01J 20/20; B01J 20/261; B01J 20/28004; B01J 20/28028; B01J 20/2803; B01J 20/28064; B01J 20/28066; B01J 20/3021; B01J 20/3078; C01B 32/318; C01B 32/336; C01B 32/354; D01F 6/06; B01D 53/02; B01D 2253/102; B01D 2253/304; B01D 2253/306; C01P 2004/61; C01P 2006/12

(57) ABSTRACT

A method for manufacturing coffee activated carbon includes performing a main treatment process of carbonizing and activating dried coffee powder particles to produce coffee activated carbon, and performing a post-treatment process of grinding, sieving, and drying the coffee activated carbon to select coffee activated carbon having an average particle diameter (D₅₀) of greater than 0 μm to 3 μm or less, coffee activated carbon prepared thereby, and a dope-dyed yarn including the coffee activated carbon.

### CROSS REFERENCE TO RELATED APPLICATIONS

This application claims benefit of priority to Korean Patent Application No. 10-2023-0064257 filed on May 18, 2023 in the Korean Intellectual Property Office, the disclosure of which is incorporated herein by reference in its entirety.

### BACKGROUND

### 1. Field

The present disclosure relates to a method for manufacturing coffee activated carbon using coffee wastes, coffee activated carbon produced thereby, and a dope-dyed yarn including the coffee activated carbon.

### 2. Description of Related Art

Recently, as coffee consumption has gradually increased, the amount of discharged coffee residues (hereinafter referred to as ‘coffee waste’) remaining after processing coffee beans is also increasing. Specifically, only about 1 to 2% by weight of coffee beans are used as an undiluted coffee solution, and most of the coffee beans are discharged as coffee waste, resulting in a huge amount of coffee waste. Most such coffee waste is buried or incinerated, but there may be a problem in that groundwater may be contaminated when the coffee waste containing moisture and various organic materials is buried, and environments may be contaminated because greenhouse gases are discharged when the coffee waste is incinerated. Accordingly, there is a need to develop a technology for eco-friendly processing of coffee waste.

In this regard, Korean Patent Publication No. 10-1999-0070311 and Korean Patent Publication No. 10-2006-0108345 disclose technology for producing activated carbon using coffee waste. In this manner, technology for environmentally friendly processing of coffee waste by recycling the coffee waste to produce activated carbon without landfill or incineration treatment is being actively developed.

Meanwhile, such coffee activated carbon may have excellent odor decomposition efficiency, odor shielding efficiency, or the like, and thus, development of technology for applying coffee activated carbon to articles requiring an odor decomposition function, an odor shielding function, or the like is actively underway.

### SUMMARY

An aspect of the present disclosure is to provide a method for manufacturing coffee activated carbon using coffee waste, coffee activated carbon produced thereby, and a dope-dyed yarn including the coffee activated carbon to have an odor decomposition function and an odor shielding function.

According to an aspect of the present disclosure, a method for manufacturing coffee activated carbon includes performing a main treatment process of carbonizing and activating dried coffee powder particles to produce coffee activated carbon, and performing a post-treatment process of grinding, sieving, and drying the coffee activated carbon to select coffee activated carbon having an average particle diameter (D₅₀) of greater than 0 μm to 3 μm or less.

According to another aspect of the present disclosure, coffee activated carbon is prepared according to the above method, and has a BET specific surface area of 1000 m²/g or more and an average particle diameter D₅₀ of 3 μm or less.

According to another aspect of the present disclosure, a dope-dyed yarn includes the coffee activated carbon.

### BRIEF DESCRIPTION OF THE FIGURES

The above and other aspects, features, and advantages of the present disclosure will be more clearly understood from the following detailed description, taken in conjunction with the accompanying drawings, in which:

FIGS. 1, 2, and 3 are flowcharts illustrating a method for manufacturing coffee activated carbon according to example embodiments of the present disclosure.

FIG. 4 is a flowchart illustrating a method for manufacturing a dope-dyed yarn according to example embodiments of the present disclosure.

FIG. 5 is a view illustrating scanning electron microscope (SEM) analysis results of cross-sections and side surfaces of dope-dyed yarns of inventive examples 1 to 4 and comparative examples 1 and 2.

FIG. 6 is a view illustrating the color evaluation results of dope-dyed yarns of inventive examples 1 to 4 and comparative examples 1 and 2.

### DETAILED DESCRIPTION

Hereinafter, various embodiments according to the present disclosure will be described, but the embodiments may be modified in various forms, and the scope thereof is not limited to embodiments described below.

### Method for Manufacturing Coffee Activated Carbon

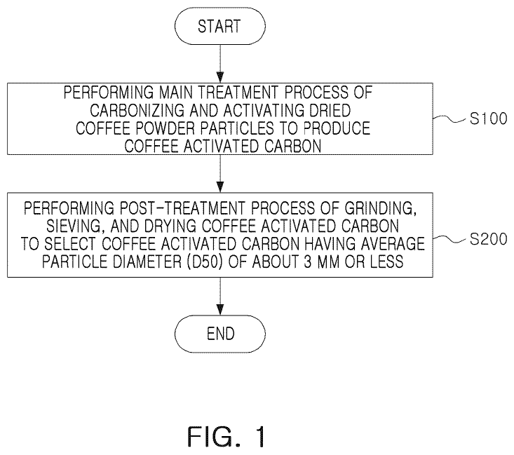

A method for manufacturing coffee activated carbon using coffee waste, according to the present disclosure, will be described with reference to FIGS. 1 to 3. FIGS. 1 to 3 are flowcharts illustrating a method for manufacturing coffee activated carbon according to example embodiments of the present disclosure.

Referring to FIG. 1, a method for manufacturing coffee activated carbon according to example embodiments of the present disclosure may include performing a main treatment process (S100) and performing a post-treatment process (S200).

First, a main treatment process of carbonizing and activating dried coffee powder particles to produce coffee activated carbon may be performed. Thereafter, a post-treatment process of grinding, sieving, and drying the coffee activated carbon to select coffee activated carbon having an average particle diameter (D₅₀) of greater than about 0 μm to about 3 μm or less may be performed.

In an embodiment, the dried coffee powder particles may be acquired by a pre-treatment process including performing a first drying process of drying coffee waste to remove moisture therefrom, and performing a first sieving process of sieving dried coffee waste to recover the dried coffee powder particles from the dried coffee waste.

In the pre-treatment process, first, the first drying process of drying coffee waste to remove moisture therefrom may be performed.

In example embodiments, the coffee waste may include about 60% by weight or more of moisture, based on a total weight of the coffee waste, and the dried coffee waste, dried in the first drying process, may include about 10% to about 15% by weight or less of moisture, based on the total weight of the coffee waste.

In an embodiment, the first drying process may be performed by introducing the coffee waste in an oven device and drying the same at a temperature of about 100 to about 120° C. for about 2 to about 5 hours.

Thereafter, the first sieving process of sieving dried coffee waste to remove a foreign substance such as a vinyl-based material or the like from the dried coffee waste, to recover the dried coffee powder particles from the dried coffee waste, may be performed.

In the performing a first sieving process, the dried coffee waste may be sieved through a sieve having a sieve opening of about 1900 to about 4040 μm, and the dried coffee powder particles having an average particle diameter (D₅₀) of about 400 μm to about 3000 μm may be acquired. As the foreign substance included in the dried coffee waste is removed by the first sieving process, the dried coffee powder particles having a particle diameter in the above-described range may be recovered, and contamination by a foreign substance, deterioration in heat transfer efficiency, or the like may be prevented in the main treatment process to be described later. Therefore, coffee activated carbon having high quality may be produced.

In an embodiment, the first sieving process may be performed by introducing the dried coffee waste into a vibrating screen device and subjecting the same to vibrating screening for about 10 to 30 minutes.

In the performing a pre-treatment process, after the first sieving process is performed, the first drying process may be performed.

In detail, the dried coffee powder particles may be acquired by a pre-treatment process including performing a first sieving process of sieving coffee waste to recover a coffee powder particles from the sieved coffee waste, and performing a first drying process of drying the coffee powder particles to remove moisture therefrom.

Therefore, after first removing a foreign substance such as a vinyl-based material or the like from the sieved coffee waste by the first sieving process and recovering the coffee powder particles, the moisture included in the coffee powder particles may be removed by the first drying process.

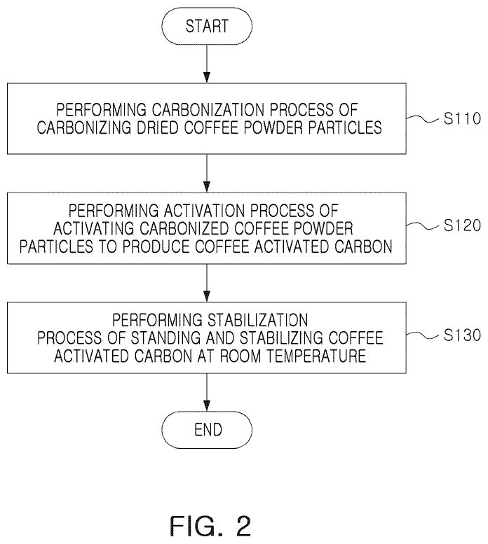

Referring to FIGS. 1 and 2, the performing a main treatment process (S100) may include performing a carbonization process (S110) and performing an activation process (S120).

First, the carbonization process of carbonizing the dried coffee powder particles may be performed.

In the performing a carbonization process (S110), the dried coffee powder particles may be introduced into a thermal decomposition furnace and carbonized at a temperature of about 300 to about 750° C.

Moisture and volatile carbon may be volatilized from the dried coffee powder particles by the carbonization process, such that the dried coffee powder particles may contain only fixed carbon. The moisture and the volatile carbon may be gasified and discharged externally through the thermal decomposition furnace.

When the dried coffee powder particles are carbonized at a temperature lower than about 300° C., an organic substance may remain due to insufficient volatilization of the moisture and the volatile carbon. When the dried coffee powder particles are carbonized at a temperature higher than about 750° C., a large amount of energy or fuel may be required. Therefore, costs for manufacturing the coffee activated carbon may increase.

In an embodiment, the carbonization process may be performed for about 1 to about 4 hours.

In an example embodiment, the thermal decomposition furnace may be in an inactive state. Specifically, the thermal decomposition furnace may be in an inactive state by introducing an inert gas into the thermal decomposition furnace or recycling a portion of exhaust gas discharged through an outlet of the thermal decomposition furnace to the thermal decomposition furnace. The exhaust gas may include, for example, carbon dioxide (CO₂).

In an embodiment, the inert gas may include, for example, at least one selected from the group consisting of nitrogen (N₂), carbon dioxide (CO₂), and argon (Ar).

Thereafter, the activation process of activating a carbonized coffee powder particles to produce the coffee activated carbon may be performed.

In the performing the activation process (S120), the carbonized coffee powder particles and active gas may be introduced into the thermal decomposition furnace to activate the carbonized coffee powder particles at a temperature of about 900 to about 1100° C. to prepare the coffee activated carbon.

In an embodiment, the activation process may be performed for about 2 to about 6 minutes.

The coffee activated carbon may have a pore structure by the activation process. Specifically, pores of various sizes, such as macropores, mesopores, micropores, or the like may be formed in the coffee activated carbon by the activation process.

Therefore, the coffee activated carbon may have a high BET specific surface area.

In an embodiment, the coffee activated carbon may have a BET specific surface area of about 1000 m²/g or more. A dope-dyed yarn including the coffee activated carbon having a BET specific surface area in the above range may have an odor decomposition function and an odor shielding function.

When the carbonized coffee powder particles are activated at a temperature lower than about 900° C., micropores may not be sufficiently formed in the coffee activated carbon, and the coffee activated carbon may not have a BET specific surface area of about 1000 m²/g or more. When the carbonized coffee powder particles are activated at a temperature higher than about 1100° C., a large amount of energy or fuel may be required. Therefore, costs for manufacturing the coffee activated carbon may increase.

In an embodiment, the active gas may include, for example, at least one selected from the group consisting of steam (H₂O), carbon dioxide (CO₂), potassium hydroxide (KOH), sodium hydroxide (NaOH), potassium carbonate (K₂CO₃), zinc chloride (ZnCl₂), and phosphoric acid (H₃PO₄).

In a process in which the dried coffee powder particles is formed into the coffee activated carbon by the carbonization process and the activation process, agglomeration between the dried coffee powder particles may occur to increase a particle diameter of the coffee activated carbon. Specifically, the coffee activated carbon may have a particle diameter distribution of about 10 to about 5000 μm or less.

In example embodiments, the performing a main treatment process (S100) may further include, after the performing an activation process (S120), performing a stabilization process of standing and stabilizing the coffee activated carbon at room temperature (S130). In this case, the room temperature may be, for example, about 5 to about 40° C., or about 10 to about 30° C., or about 15 to about 25° C., preferably about 25° C.

The pore structure of the coffee activated carbon may be stabilized by the stabilization process.

In an embodiment, the stabilization process may be performed for about 2 to about 6 hours.

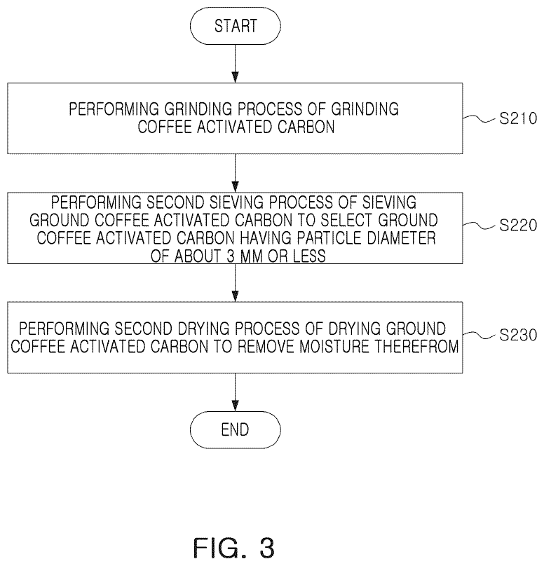

Referring to FIGS. 1 and 3, the performing a post-treatment process (S200) may include a grinding process (S210), a second sieving process (S220), and a second drying process (S230).

First, the grinding process of grinding the coffee activated carbon may be performed.

In the performing a grinding process, the coffee activated carbon may be ground to have an average particle diameter (D₅₀) of about 7 μm or less. As the coffee activated carbon is ground to have an average particle diameter (D₅₀) within the above range, ground coffee activated carbon having an average particle diameter (D₅₀) of about 3 μm or less may be more smoothly selected in the second sieving process.

The grinding process may be performed by grinding the coffee activated carbon a plurality of times. Specifically, in the grinding process, the coffee activated carbon may be introduced into a blade mill for primary grinding at about 1000 g/hr, and may be then introduced into an air get mill for secondary grinding at about 150 to about 1000 g/hr.

Thereafter, the second sieving process of sieving a ground coffee activated carbon to select the ground coffee activated carbon having an average particle diameter (D₅₀) of 3 μm or less may be performed.

In the performing a second sieving process (S220), the ground coffee activated carbon may be sieved through a sieve having a sieve opening of about 6.5 μm to about 13 μm. A dope-dyed yarn including sieved coffee activated carbon having the above-described average particle diameter (D₅₀) of about 3 μm or less may have an odor decomposition function and an odor shielding function, and the dope-dyed yarn may be used to manufacture a short fiber or a filament yarn using a fiber spinning device.

In an embodiment, the second sieving process may be performed by introducing the ground coffee activated carbon into a vibrating screen device and subjecting the same to vibrating screening for about 1 to about 3 hours.

Thereafter, the second drying process of drying the ground coffee activated carbon selected in the second sieving process to remove moisture therefrom may be performed.

The second drying process (S230) may be performed such that moisture adsorbed in pores of the ground coffee activated carbon is removed and the moisture is about 5% by weight or less, based on a total weight of the ground coffee activated carbon. As the ground coffee activated carbon includes the moisture within the above-described range, the moisture, instead of gas, may be attached to adsorption points on a surface of the ground coffee activated carbon, to minimize deterioration in odor decomposition efficiency. In addition, when spinning fibers using a dope-dyed yarn including the ground coffee activated carbon, deterioration of properties of the dope-dyed yarn due to hydrolysis of a polymer used in the spinning fibers or the like may be minimized.

As the ground coffee activated carbon includes the moisture within the above-described range, the moisture, instead of gas, may be attached to adsorption points on a surface of the ground coffee activated carbon, to minimize deterioration in odor decomposition efficiency.

In an embodiment, the second drying process may be performed by introducing the ground coffee activated carbon in an oven device and drying the same at a temperature of about 100 to about 120° C. for about 1 to about 2 hours.

In this manner, preparation of the coffee activated carbon may be completed.

As described above, the main treatment process of carbonizing and activating dried coffee powder particles to produce coffee activated carbon may be performed, and the post-treatment process of grinding, sieving, and drying the coffee activated carbon to select coffee activated carbon having an average particle diameter (D₅₀) of about 3 μm or less may be performed, to prepare the coffee activated carbon, and a dope-dyed yarn including the coffee activated carbon may have an odor decomposition function and an odor shielding function.

### Method for Manufacturing Dope-Dyed Yarn

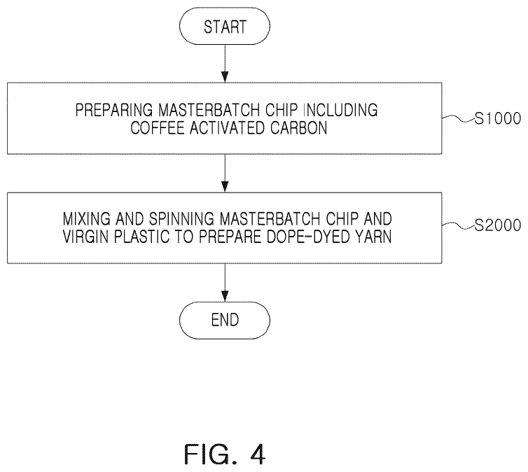

Hereinafter, a method for manufacturing a dope-dyed yarn according to the present disclosure will be described with reference to FIG. 4. FIG. 4 is a flowchart illustrating a method for manufacturing a dope-dyed yarn according to example embodiments of the present disclosure.

Referring to FIG. 4, a method for manufacturing a dope-dyed yarn according to example embodiments of the present disclosure may include preparing a masterbatch chip including coffee activated carbon (S1000), and preparing a dope-dyed yarn by melt-spinning the masterbatch chip (S2000).

First, a masterbatch chip including coffee activated carbon may be prepared.

Specifically, a masterbatch chip may be prepared by introducing and extruding coffee activated carbon and a recycled material into an extruder.

In example embodiments, the masterbatch chip may include about 10% by weight or less of the coffee activated carbon, based on a total weight of the masterbatch chip.

In example embodiments, the recycled material may include, for example, at least one selected from the group consisting of polypropylene (PP), polyamide (PA), polyethylene terephthalate (PET), and polyurethane (PU), acquired by recycling scrap car components, discarded fishing nets, household waste, or the like.

Thereafter, the dope-dyed yarn may be prepared by mixing and spinning the masterbatch chip and a virgin plastic.

Specifically, the dope-dyed yarn may be prepared by introducing and mixing the master batch chip and a virgin plastic in a spinning machine, followed by melt spinning, stretching, and winding the same.

When the masterbatch chip includes the coffee activated carbon within the above-described range, an increase in pack pressure during spinning of the dope-dyed yarn may be suppressed, and breakage of the dope-dyed yarn may be prevented during spinning, stretching, and winding of the dope-dyed yarn.

In example embodiments, the dope-dyed yarn may include about 50% by weight or less of the masterbatch chips, based on a total weight of the dope-dyed yarn. Therefore, the dope-dyed yarn may include about 3% by weight or less, specifically, 0.1 to 3% by weight of the coffee activated carbon, based on the total weight of the dope-dyed yarn. When the dope-dyed yarn includes more than about 3% by weight of the coffee activated carbon, based on the total weight of the dope-dyed yarn, pack pressure may excessively increase during spinning of the dope-dyed yarn, and breakage of the dope-dyed yarn may occur during spinning, stretching, and winding of the dope-dyed yarn.

In example embodiments, the virgin plastic may include, for example, at least one polymeric material selected from the group consisting of polypropylene, polyamide, polyethylene terephthalate, and polyurethane.

In this manner, preparation of the dope-dyed yarn may be completed.

As described above, as the dope-dyed yarn includes about 3% by weight or less of the coffee activated carbon, based on the total weight of the dope-dyed yarn, an increase in pack pressure during spinning of the dope-dyed yarn may be suppressed, and breakage of the dope-dyed yarn may be prevented during spinning, stretching, and winding of the dope-dyed yarn. Therefore, the dope-dyed yarn may be replaced with a dope-dyed yarn not including a conventional coffee activated carbon, for example, a dope-dyed yarn including only virgin plastic, and furthermore may have an odor decomposition function and an odor shielding function, which have not be achieved by a conventional dope-dyed yarn.

The coffee activated carbon may have a black color. Therefore, the masterbatch chip including the coffee activated carbon may have a black color, and the dope-dyed yarn including the masterbatch chip may also have a black color. Conventionally, to produce a dope-dyed yarn having a black color, carbon black may be used. Since such carbon black may be mainly produced from fossil fuels, there may be a problem of emitting carbon dioxide, a sulfur oxide, or the like in a process of manufacturing carbon black to pollute the atmosphere. In example embodiments, as the coffee activated carbon may be used to prepare the dope-dyed yarn having a black color, since the coffee activated carbon may be replaced with the carbon black, a method for manufacturing the dope-dyed yarn may be eco-friendly technology that prevents air pollution generated when manufacturing a conventional dope-dyed yarn having a black color.

### EXAMPLE

Hereinafter, the present disclosure will be more specifically described by way of specific examples. However, the following examples represent an embodiment of the present disclosure, and the present disclosure is not limited thereto.

### Preparation of Coffee Activated Carbon

After preparing coffee waste including 60% by weight of moisture, based on a total weight of the coffee waste, the coffee waste was introduced into an oven device (S-SHOV150) of SCENG corporation, and dried at a temperature of 120° C. for 4 hours. Dried coffee waste included 13% by weight of moisture, based on the total weight of the dried coffee waste.

Thereafter, the dried coffee waste was introduced into a vibrating screen device (XZS400) of Hwashin Instrument Co., Ltd., and subjected to vibration screening for 30 minutes. In detail, the dried coffee waste was sieved through a sieve having a sieve opening of 1900 μm to recover a coffee powder particles.

Then, an average particle diameter (D₅₀) of the coffee powder particles was measured using ZEN3600 of Malvern Instruments Inc. In this case, the average particle diameter (D₅₀) of the coffee powder particles was measured as 400 μm.

Thereafter, the coffee powder particles were introduced into a thermal decomposition furnace of Korea Thermotech Co., Ltd., and carbonized for 1 hour at a temperature of 750° C. When carbonizing the coffee powder particles, carbon dioxide (CO₂) was injected into the thermal decomposition furnace, to maintain the thermal decomposition furnace in an inactive state.

Thereafter, steam (H₂O) was introduced into the thermal decomposition furnace to activate a carbonized coffee powder particles at a temperature of 1100° C. for 3 minutes. As a result, coffee activated carbon having a pore structure was prepared.

Then, a BET specific surface area of the coffee activated carbon was measured using ASAP2420 of Micromeritics Ltd. In detail, helium was used as a carrier gas, nitrogen was used as an adsorption gas, and the BET specific surface area was measured in a five predefined point method of a BET relative pressure (P/P₀, where P is an actual measured pressure, and P₀ is a saturation pressure) by a continuous flow method. In this case, the BET specific surface area of the coffee activated carbon was measured as 1380 m²/g.

In addition, an average particle diameter (D₅₀) of the coffee activated carbon was measured using ZEN3600 of Malvern Instruments Inc. In this case, the average particle diameter (D₅₀) of the coffee activated carbon was measured as 850 μm.

Thereafter, the coffee activated carbon was allowed to stand at room temperature (25° C.) to stabilize for 4 hours.

Thereafter, the coffee activated carbon was introduced into a blade mill of KM Tech Co., Ltd., was first ground at 1000 g/hr, and was then introduced into an air jet mill (JM-LB) of KM Tech Co., Ltd. to be secondly ground at 500 g/hr. An average particle diameter (D₅₀) of secondly ground coffee activated carbon was measured using ZEN3600 of Malvern Instruments Inc. In this case, the average particle diameter (D₅₀) of the secondly ground coffee activated carbon was measured to be 5.7 μm.

Thereafter, the secondly ground coffee activated carbon was introduced into a vibrating screen device (XZS400) of Hwashin Machinery Co., Ltd., and subjected to vibration screening for 3 hours. In detail, the secondly ground coffee activated carbon was sieved through a sieve having a sieve opening of 6.5 μm to select the coffee activated carbon.

Thereafter, an average particle diameter (D₅₀) of selected coffee activated carbon was measured ZEN3600 of Malvern Instruments Inc. In this case, the average particle diameter (D₅₀) of the selected coffee activated carbon was measured to be 2.6 μm.

Thereafter, the selected coffee activated carbon was introduced into an oven device (S-SHOV150) of SCENG corporation, and dried at a temperature of 100° C. for 2 hours. Dried coffee activated carbon included 5% by weight of moisture, based on a total weight of the dried coffee activated carbon.

Therefore, coffee activated carbon was prepared.

### INVENTIVE EXAMPLES 1 TO 4 AND COMPARATIVE EXAMPLES 1 AND 2

### Inventive Example 1

A masterbatch chip was prepared by extruding the coffee activated carbon and recycled polypropylene (PP) into an extruder (HSE45FN) of Korea EM Co., Ltd. In this case, the masterbatch chip included 10% by weight of the coffee activated carbon, based on a total weight of the masterbatch chip.

Thereafter, the masterbatch chip and a polypropylene (PP) virgin plastic were introduced into a spinning machine of MS LAB #3 of Textile Development Research Institute, were mixed, melt spinned, stretched, and wound to prepare a dope-dyed yarn of Inventive Example 1. In this case, the dope-dyed yarn of Example 1 included 5% by weight of the masterbatch chip and 95% by weight of the polypropylene virgin plastic, based on a total weight of the dope-dyed yarn, and thus 0.5% by weight of the coffee activated carbon, based on the total weight of the dope-dyed yarn.

### Inventive Examples 2 to 4

Dope-dyed yarns of Inventive Examples 2 to 4 were manufactured using the coffee activated carbon including the dope-dyed yarn of Inventive Example 1 and in the same manufacturing method as the method of manufacturing the dope-dyed yarn of Inventive Example 1, respectively.

A dope-dyed yarn of Inventive Example 2 included 10% by weight of a masterbatch chip and 90% by weight of a polypropylene virgin plastic, based on a total weight of the dope-dyed yarn, and thus 1% by weight of coffee activated carbon, based on the total weight of the dope-dyed yarn.

A dope-dyed yarn of Inventive Example 3 included 20% by weight of a masterbatch chip and 80% by weight of a polypropylene virgin plastic, based on a total weight of the dope-dyed yarn, and thus 2% by weight of coffee activated carbon, based on the total weight of the dope-dyed yarn.

A dope-dyed yarn of Inventive Example 4 included 30% by weight of a masterbatch chip and 70% by weight of a polypropylene virgin plastic, based on a total weight of the dope-dyed yarn, and thus 3% by weight of coffee activated carbon, based on the total weight of the dope-dyed yarn.

### Comparative Example 1

A dope-dyed yarn of Comparative Example 1 was manufactured by introducing a polypropylene virgin plastic into a spinning machine of MS LAB #3 of Textile Development Research Institute, and then melt spinning, stretching, and winding the same. For example, the dope-dyed yarn of Comparative Example 1 did not include a masterbatch chip including coffee activated carbon, but included only the virgin plastic.

### Comparative Example 2

A dope-dyed yarn of Comparative Example 2 was manufactured using the coffee activated carbon including the dope-dyed yarn of Inventive Example 1 and in the same manufacturing method as the method of manufacturing the dope-dyed yarn of Inventive Example 1.

The dope-dyed yarn of Comparative Example 2 included 50% by weight of a masterbatch chip and 50% by weight of a polypropylene virgin plastic, based on a total weight of the dope-dyed yarn, and thus 5% by weight of the coffee activated carbon, based on the total weight of the dope-dyed yarn.

Table 1 below illustrates amounts of coffee activated carbon included in the dope-dyed yarns of Inventive Examples 1 to 4 and Comparative Examples 1 and 2.

TABLE 1

| | Inven- | Inven- | Inven- | Inven- | Compar- | Compar- |
|---|---|---|---|---|---|---|
| | tive | tive | tive | tive | ative | ative |
| Example | Ex. 1 | Ex. 2 | Ex. 3 | Ex. 4 | Ex. 1 | Ex. 2 |
| Amount | 0.5 | 1 | 2 | 3 | 0 | 5 |
| of Coffee | | | | | | |
| Activated | | | | | | |
| Carbon | | | | | | |
| (wt %) | | | | | | |

### Pack Pressure Change Evaluation

When spinning the dope-dyed yarns of Inventive Examples 1 to 4 and Comparative Examples 1 and 2, inlet pressure (P₁) and outlet pressure (P₂), measured by pressure sensors installed before and after a spin pack & nozzle, were measured, and according to Equation 1 below, Pack pressure changes were evaluated.

$$P ( Pa ) = {P}_{1} - {P}_{2} \qquad Equation 1$$

### Evaluation of Presence or Absence of Breakage

During spinning, stretching, and winding of the dope-dyed yarns of Examples 1 to 4 and Comparative Examples 1 and 2, the presence or absence of breakage was evaluated by visually checking whether cut fibers were wound around two rollers installed on a front end of a winder.

Table 2 below illustrates evaluation results for pack pressure change and breakage of the dope-dyed yarns of Inventive Examples 1 to 4 and Comparative Examples 1 and 2.

TABLE 2

| | Inven- | Inven- | Inven- | Inven- | Compar- | Compar- |
|---|---|---|---|---|---|---|
| | tive | tive | tive | tive | ative | ative |
| Example | Ex. 1 | Ex. 2 | Ex. 3 | Ex. 4 | Ex. 1 | Ex. 2 |
| Pack | 19.20 | 16.56 | 34.56 | 8.64 | 0.75 | 198.72 |
| Pressure | | | | | | |
| Change | | | | | | |
| (kg/cm²- | | | | | | |
| day) | | | | | | |
| Breakage | None | None | None | None | None | Occurred |

### SEM Analysis and Color Evaluation

Cross-sections and side surfaces of the dope-dyed yarns of Inventive Examples 1 to 4 and Comparative Examples 1 and 2 were analyzed with a scanning electron microscope (SEM), and colors thereof were visually evaluated.

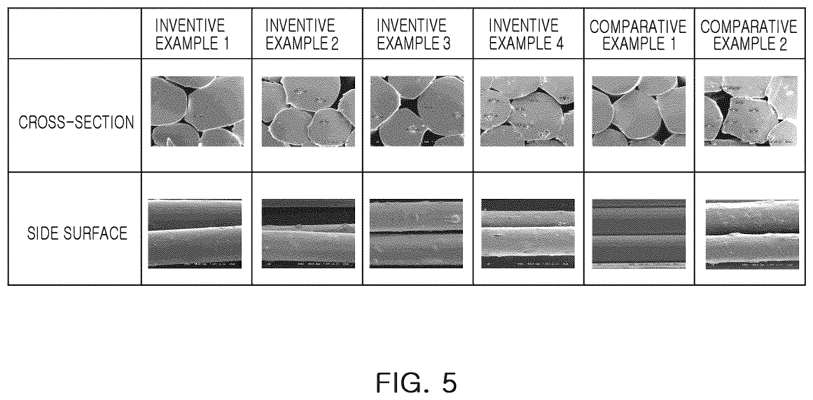

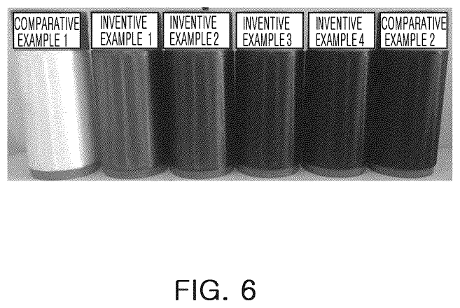

SEM analysis results and color evaluation results of cross-sections and side surfaces of the dope-dyed yarns of Inventive Examples 1 to 4 and Comparative Examples 1 and 2 were illustrated in FIGS. 5 and 6, respectively.

As can be seen from Tables 1 and 2, it was confirmed that the dope-dyed yarns of Inventive Examples 1 to 4 had a low pack pressure change value during spinning, and breakage did not occur during spinning, stretching, and winding. From this, it can be seen that even when the dope-dyed yarn of the present disclosure includes the coffee activated carbon, an increase in pack pressure is suppressed during spinning, and breakage of the dope-dyed yarn is prevented during spinning, stretching, and winding.

It was confirmed that the dope-dyed yarns of Inventive Examples 1 to 4 had a higher pack pressure change value than the dope-dyed yarn of Comparative Example 1. As the dope-dyed yarns of Inventive Examples 1 to 4 included the coffee activated carbon, it was determined to have a higher pack pressure change value than the dope-dyed yarn of Comparative Example 1 including only the polypropylene virgin plastic. In view of results that the dope-dyed yarns of Inventive Examples 1 to 4 did not break during spinning as the same as the dope-dyed yarns of Comparative Example 1, pack pressure change values of the dope-dyed yarns of Inventive Examples 1 to 4 are judged as not being reduced for spinning fairness. Therefore, it can be seen that the dope-dyed yarn of the present disclosure may be substituted for the dope-dyed yarn including only a conventional virgin plastic.

In addition, it was confirmed that the dope-dyed yarns of Inventive Examples 1 to 4 had a lower pack pressure change value than the dope-dyed yarns of Comparative Example 2, and breakage occurred during spinning, stretching, and winding. From this, as a dope-dyed yarn of the present disclosure includes about 3% by weight or less of coffee activated carbon, based on a total weight of the dope-dyed yarn, it can be seen that an increase in pack pressure during spinning of the dope-dyed yarn is suppressed, and breakage of the dope-dyed yarn is prevented during spinning, stretching, and winding of the dope-dyed yarn.

In addition, as can be seen from Table 1, FIGS. 5 and 6, the dope-dyed yarns of Inventive Examples 1 to 4 have a black color due to inclusion of coffee activated carbon in an internal space and on a surface thereof, whereas the dope-dyed yarn of Comparative Example 1 has a white color due to no inclusion of coffee activated carbon in an internal space and on a surface thereof. From this, it can be seen that the dope-dyed yarn of the present disclosure has a black color as due to inclusion of the coffee activated carbon. Therefore, since the coffee activated carbon may be replaced with carbon black, it can be seen that the manufacturing method of the dope-dyed yarn may be eco-friendly technology that prevents air pollution generated during manufacturing of a conventional dope-dyed yarn having a black color.

Although embodiments of the present disclosure have been described in detail above, these are merely illustrative, and those skilled in the art will understand that various modifications and equivalent other embodiments are possible therefrom. Therefore, the true technical scope of protection of the present disclosure should be determined by the technical spirit of the appended claims.

Specific executions described in embodiments are illustrative, and do not limit the scope of the embodiments in any manner. In addition, when there is no specific reference such as “essential,” “important,” or the like, it is not necessarily a component necessary for application of the present disclosure.

In the specification of the embodiments (particularly in the claims), the use of the term “the” and similar indicating terms may correspond to both singular and plural. In addition, when a range is described in the embodiments and examples, it includes the invention to which individual values belonging to the range are applied (unless there is a description to the contrary), and it is as if each individual value constituting the above range was described in the detailed description. Finally, if there is no explicit description or description of the order of steps constituting the method according to the embodiment, the steps (operations) may be performed in an appropriate order. Examples are not necessarily limited according to the order of description of the steps. The use of all examples or illustrative terms (e.g., etc., the like) in the embodiments are merely intended to describe the embodiments in detail. Unless limited by the claims, the scope of the embodiments is not limited due to the above examples or illustrative terms. In addition, those skilled in the art may appreciate that various modifications, combinations and changes may be made according to design conditions and factors within the scope of the appended claims or equivalents thereof.

In a method for manufacturing coffee activated carbon according to example embodiments of the present disclosure, a main treatment process of carbonizing and activating dried coffee powder particles to produce coffee activated carbon may be performed and a post-treatment process of grinding, sieving, and drying the coffee activated carbon to select coffee activated carbon having an average particle diameter (D₅₀) of greater than 0 μm to 3 μm or less may be performed, to prepare the coffee activated carbon, and a dope-dyed yarn including the coffee activated carbon may have an odor decomposition function and an odor shielding function.

In addition, since a dope-dyed yarn according to example embodiments of the present disclosure includes 3% by weight or less of the coffee activated carbon, based on a total weight of the dope-dyed yarn, an increase in pack pressure during spinning may be suppressed, and breakage of the dope-dyed yarn during spinning, stretching, and winding may be prevented. Therefore, the dope-dyed yarn according to example embodiments of the present disclosure may be replace with a dope-dyed yarn not including a conventional coffee activated carbon, for example, a dope-dyed yarn including only a virgin plastic, and furthermore may have an odor decomposition function and an odor shielding function, which is not achieved by a conventional dope-dyed yarn.

In addition, since a dope-dyed yarn according to example embodiments of the present disclosure is prepared using the coffee activated carbon to have a black color, the coffee activated carbon may be replaced with carbon black. Therefore, a method for manufacturing a dope-dyed yarn according to example embodiments of the present disclosure may be environmentally friendly technology that prevents air pollution generated during the production of a conventional dope-dyed yarn having a black color.

While example embodiments have been illustrated and described above, it will be apparent to those skilled in the art that modifications and variations could be made without departing from the scope of the present disclosure as defined by the appended claims.

1. A method for manufacturing coffee activated carbon, comprising:
performing, by a thermal decomposition furnace, a main treatment process of carbonizing and activating dried coffee powder particles to produce coffee activated carbon; and
performing a post-treatment process of grinding, by a grinder, sieving, by a sieve, and drying, by an oven device, the coffee activated carbon to select coffee activated carbon having an average particle diameter (D₅₀) of greater than 0 μm to 3 μm or less.

2. The method of claim 1, wherein the dried coffee powder particles are acquired by a pre-treatment process comprising:
performing, by a first drying process of drying coffee waste to remove moisture therefrom; and
performing a first sieving process of sieving, by a sieve, dried coffee waste to recover the dried coffee powder particles from the dried coffee waste.

3. The method of claim 2, wherein, in the performing a first sieving process,
the dried coffee waste is sieved through the sieve which has a sieve opening of 1900 μm to 4040 μm.

4. The method of claim 1, wherein the performing a main treatment process comprises:
performing a carbonization process of carbonizing the dried coffee powder particles; and
performing an activation process of activating a carbonized coffee powder particles to produce the coffee activated carbon.

5. The method of claim 4, wherein, in the carbonization process,
the dried coffee powder particles are introduced into the thermal decomposition furnace and carbonized at a temperature of 300 to 750° C.

6. The method of claim 5, wherein an inert gas is introduced into the thermal decomposition furnace to carbonize the dried coffee powder particles,
wherein the inert gas is at least one selected from the group consisting of nitrogen (N₂), carbon dioxide (CO₂), and argon (Ar).

7. The method of claim 4, wherein, in the activation process,
the carbonized coffee powder particles and active gas are introduced into the thermal decomposition furnace to activate the carbonized coffee powder particles at a temperature of 900 to 1100° C. to prepare the coffee activated carbon.

8. The method of claim 7, wherein the active gas is at least one selected from the group consisting of steam (H₂O), carbon dioxide (CO₂), potassium hydroxide (KOH), sodium hydroxide (NaOH), potassium carbonate (K₂CO₃), zinc chloride (ZnCl₂), and phosphoric acid (H₃PO₄).

9. The method of claim 4, wherein the main treatment process further comprises:
after performing the activation process, performing a stabilization process of standing and stabilizing the coffee activated carbon at room temperature.

10. The method of claim 1, wherein performing the post-treatment process comprises:
performing a grinding process of grinding the coffee activated carbon;
performing a second sieving process of sieving a ground coffee activated carbon to select the ground coffee activated carbon having an average particle diameter (D₅₀) of 3 μm or less; and
performing a second drying process of drying the ground coffee activated carbon selected by the second sieving process to remove moisture therefrom.

11. The method of claim 10, wherein, in the second sieving process,
the ground coffee activated carbon is sieved through a sieve having a sieve opening of 6.5 μm to 13 μm.

12. The method of claim 10, wherein the second drying process is carried out such that the moisture of the ground coffee activated carbon is 5% by weight or less, based on a total weight of the ground coffee activated carbon.

13. Coffee activated carbon prepared according to the method of claim 1, having a BET specific surface area of 1000 m²/g or more and an average particle diameter (D₅₀) of 3 μm or less.

14. A dope-dyed yarn comprising the coffee activated carbon of claim 13.

15. The dope-dyed yarn of claim 14, comprising 3% by weight or less of the coffee activated carbon, based on a total weight of the dope-dyed yarn.

16. The dope-dyed yarn of claim 14, comprising:
a masterbatch chip including the coffee activated carbon; and
a virgin plastic.

17. The dope-dyed yarn of claim 16, wherein the masterbatch chip further comprises a recycled material.

18. The dope-dyed yarn of claim 17, wherein the recycled material comprises at least one selected from the group consisting of polypropylene (PP), polyamide (PA), polyethylene terephthalate (PET), and polyurethane (PU), acquired by recycling scrap car components, discarded fishing nets, or household wastes.

19. The dope-dyed yarn of claim 16, wherein the virgin plastic comprises at least one polymeric material selected from the group consisting of polypropylene, polyamide, polyethylene terephthalate, and polyurethane.
